(19) United States
(12) Patent Application Publication
(10) Pub. No.: US 2013/0219664 A1
(43) Pub. Date: Aug. 29, 2013

(54) HINGE WITH INTEGRATED ADJUSTABLE STOP AND SECURITY FEATURE

(71) Applicant: Brian James Burda, Navarre, FL (US)

(72) Inventor: Brian James Burda, Navarre, FL (US)

(21) Appl. No.: 13/332,857

(22) Filed: Feb. 29, 2012

(51) Int. Cl. E05D 11/06

(52) U.S. Cl. 16/374

(57) ABSTRACT

The present invention is a simple modification of an existing door hinge which stops the swing-open motion of a door to one or more multiple angles on the swing of the hinge stopping the door before the door or door hardware can hit an adjacent object. The most popular angles are ninety degrees, one hundred and thirty five degrees, and one hundred and eighty degrees to the closed door. Optional opening degrees may be selected during the manufacturing process creating multiple degree positions according to the number of knuckles on the hinge. By stopping the motion of the door at the desired position, the door or protruding hardware of the door will not damage an adjacent wall or object. Frequent repairs and replacements are therefore avoided by eliminating contact with a wall or object. The modified door hinge is adaptable to various residential and commercial applications.

BACKGROUND OF THE PRESENT INVENTION

The present invention relates generally to the field of hardware for residential and commercial doors and more specifically to the field of devices which limit the swing open motion of an interior or exterior door to a single angle or multiple angles depending on the number of hinge knuckles on a hinge leaf to prevent the door and protruding hardware from hitting a wall, door casing surroundings or object.

The field of devices which limit the swing-open motion of doors has been studied extensively and a number of approaches have been developed. This field is important because without limiting the swing of a door, the protruding hardware can hit, penetrate, or break an adjacent object adding additional expenses due to repair or replacement of the damaged object. The primary devices used today to limit the swing-open motion of a door are mounted to the floor adjacent to the wall to be protected, mounted on the base molding of the wall itself, mounted on the wall where the door hardware would make contact, or mounted on the hinge pin. A review of door hinge devices has not revealed a door hinge for residential or commercial use which incorporates features directly into the hinge to address this problem.

### SUMMARY OF THE INVENTION

In view of the foregoing disadvantages inherent in the known types of hinges which limit the maximum swing of door, the present invention makes available a door hinge that has a minimum swing of five degrees to a maximum swing of three hundred and twenty five degrees. The hinge can be modified to accommodate a minimum of one stop angle to a maximum of the available knuckles on a single hinge thus making the hinge extremely simplistic and flexible for a variety of residential and commercial specifications. The present invention is configured for use on residential and commercial interior and exterior doors where a variety of degree openings are required to keep the door from hitting an adjacent object. The purpose of the present invention is to stop the swing-open motion of the door before it can hit the adjacent object. By halting the swing-open motion of said door at the specified degree, the protruding hardware of a door or the door itself will not damage the adjacent wall or object causing damage that requires repair or replacement. The uniqueness of the present invention is found in the simplicity of taking an ordinary hinge and drilling a single hole in each knuckle allowing for multiple stopping point degreed angles on a single hinge. With the addition of the stopping point, which will be a cap screw, roll pin, or solid steel dowel, the desired stopping position of the door is accomplished. The hinge with integrated door stop and security feature can be installed at the time the door is manufactured since the stopping point can be installed after the door has been manufactured and the hinges installed. The hinge with integrated door stop and security feature can also be installed after the door has been mounted since it is as simple as removing the previous hinge, installing the hinge with integrated door stop and security feature, and then remounting the stopping point at the desired position.

### BRIEF DESCRIPTION OF THE DRAWINGS

FIG. 1 is a backside view of the present invention showing a hinge (1).

FIG. 2 shows an overhead view of the present invention of FIG. 1 illustrating how a hinge (1) composed of two leafs (10 and 20) can be configured for one (5), two (5 and 6), or three (5, 6, and 7) different angles on a hinge (1) with a maximum of three knuckles (30)

### DETAILED DESCRIPTION OF THE INVENTION

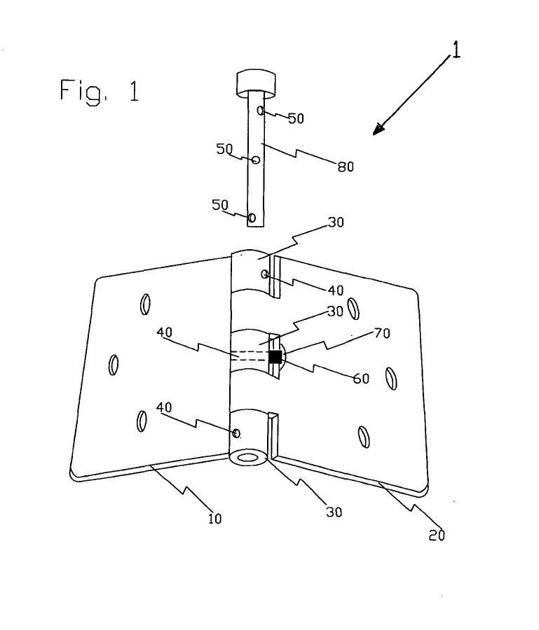

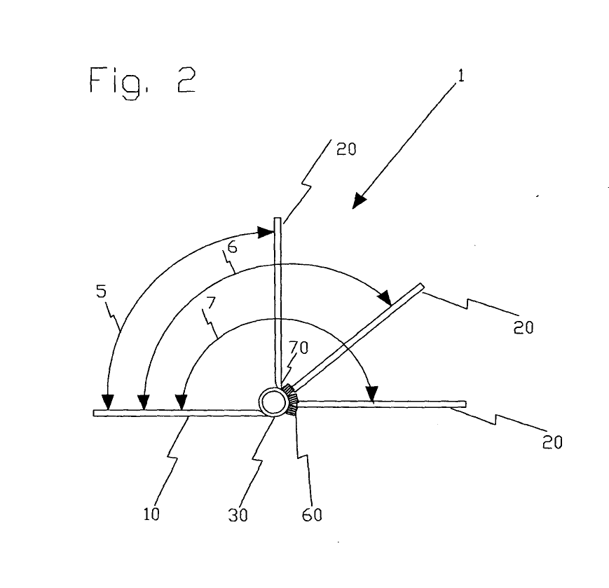

The preferred embodiment of the present invention can be best understood by reference to the drawings FIG. 1 and FIG. 2. As can be readily seen from FIG. 1, the present invention is a door hinge (1) with a minimum of one hole (40) and a maximum of holes (40) that equal the number of knuckles (30) on the hinge (1). FIG. 1 shows a hinge (1) with three holes (40), each hole (40) in a separate hinge knuckle (30) which allow for one, two or three separate stopping points (60) any one of which can be set at the desired degree with a single cap screw (60), roll pin (60) or solid steel dowel (60). FIG. 2 shows the most used angles are ninety degrees (5), one hundred thirty five degrees (6), and one hundred eighty degrees (7). Other angles can be specified for custom applications during the manufacturing process.

FIG. 1 shows the hinge (1) is composed of the two Leafs (20 and 10) and the pin (80). The hinge (1) is modified by drilling and/or tapping one, two, or three different angled holes (40) through the three individual knuckles (30). The pin (80) is also drilled through creating the same angled holes (50) during the drilling process of the knuckle(s) (30). Once the knuckle (30) and pin (80) have the desired angled hole(s) (40) in the knuckle (30) and the pin (80) the stopping point (60) can be completely inserted through the entire knuckle (30) and pin (80) thus contacting the hinge leaf (20) at the reveal (70) causing the stopping point (60) to stop the door at the desired angle.

FIG. 2 shows the most used hinge stop point (60) angles are ninety degrees (5), one hundred thirty five degrees (6), and one hundred eighty degrees (7). The hinge (1) can be modified for any desirable angle in which the insertion of the single stopping point (60) will determine the correct degree of the angle by contacting the leaf (20) at the desired stopping point (70).

Although only one embodiment of the present invention is set forth herein, it is apparent to someone skilled in the art that various changes and modifications of an obvious nature may be made without departing from the spirit of the present invention, and all such changes and modifications are considered to fall within the scope of the present invention as defined by the appended claims.

What is claimed is:

1. A door hinge comprising:
a. a hinge with two leafs wherein said leafs include joining knuckles;
b. a connection device for connecting with the joining knuckles and joining the two leafs together; and
c. a hole in said connection device and at least one of said joining knuckles; and
d. a stopper for connection with said hole such that said stopper passes through said joining knuckle and said connection device.

2. The invention of claim 1 wherein the connection device is a hinge pin.

3. The invention of claim 1 wherein more than one hole is provided wherein each of said more than one hole is at a different angle from other holes.

4. The invention of claim 1 wherein three holes are provided.

5. The invention of claim 4, wherein the three holes are drilled so as to provide stop angles consisting of approximately: ninety degrees, one hundred and thirty five degrees and one hundred eighty degrees.

6. The invention of claim 1 wherein the stopper is conformed to extend through the connection device such that a portion of the stopper is exposed.

7. The invention of claim 1 wherein the stopper includes a head and the head is flush with the joining knuckles when inserted in said hole.

8. The invention of claim 7 wherein the head makes contact with the one leaf so as to stop movement of the leaf.

9. The invention of claim 1 wherein the stopper extends approximately perpendicularly through said connection device.
